(19) United States
(12) Patent Application Publication
(10) Pub. No.: US 2005/0283653 A1
(43) Pub. Date: Dec. 22, 2005

(54) Magnetic disk device, access control method thereof and storage medium

(75) Inventors: Yasuo Noguchi, Kawasaki (JP); Riichiro Take, Kawasaki (JP); Katsuhiko Nishikawa, Kawasaki (JP); Atsuo Iida, Kawasaki (JP); Toru Yokohata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/205,041

(22) Filed: Aug. 17, 2005

Related U.S. Application Data
(63) Continuation of application No. PCT/JP03/01798, filed on Feb. 19, 2003.

(51) Int. Cl. G06F 11/00

(52) U.S. Cl. 714/6

(57) ABSTRACT

The present invention aims at offering a magnetic disk device for configuring RAID in a single disk device. The device can configure RAID using one disk and furthermore only one surface (referred to as a single-surface RAID method) neither requiring a plurality of actuators nor performing a data writing processing, etc. more than once. For that purpose, a plurality of data access heads is provided for each arm and the heads are positioned so as to access different tracks on a same surface on a disk.

### CROSS REFERENCE TO RELATED APPLICATION

This application is a continuation of international PCT application No. PCT/JP2003/001798 filed on Feb. 19, 2003.

### BACKGROUND OF THE INVENTION

1. Field of the Invention

The present invention relates to a magnetic disk device configuring RAID (Redundant Arrays of Inexpensive Disks) in a single disk device.

2. Description of the Related Art

At present, RAID (Redundant Arrays of Inexpensive Disks) is well-known as a method of enhancing the reliability of a magnetic disk. Basically, RAID is a method of redundantly storing data in a plurality of magnetic disks. That is, this method is a storage technology of enhancing both a high-speed processing and the tolerability for a fault by connecting a plurality of disks in parallel and simultaneously controlling all the disks. By adopting RAID, the reduction of data loss at the time of a disk fault, a fault-tolerant system processing at the time of a disk fault, high-speed processing due to the enhancement of a disk access efficiency, the reduction of a recovery time at the time of a disk fault, etc. can be expected.

At present, methods such as RAID1, RAID3, RAID 4 and RAID 5 are mainly well known.

The RAID1 is called “mirroring” and it is configured to realize redundancy by writing the same data on two disks.

The RAID3 is a method of reconfiguring lost data from the remaining divided data and the parity by generating and storing divided data and parity when one divided data is lost. According to this method, the divided data and the parity are simultaneously accessed to be controlled.

RAID4 and RAID5 are methods similar to RAID 3 and accordingly the two methods are not especially explained here.

Here, RAID is generally realized by using a plurality of independent hard disks in parallel as if they were like one disk device. Namely, RAID requires a plurality of magnetic disk devices. Furthermore, since RAID requires a control device for dividing and reconfiguring data or for synchronizing a plurality of magnetic disk devices, the configuration becomes complicated and expensive.

In respect of the above-mentioned configuration, a method of configuring RAID in a single magnetic disk device has been proposed.

In respect of the conventional technology, there are, for example, publicly-known documents such as patent literatures 1 to 6, etc. that are explained below (some documents which are not directly related to RAID but the configurations of which should be taken into consideration are included.)

It is conceivable that two hard disk devices are used to realize a mirroring function using conventional hard disk devices. However, for example, in the invention disclosed in Japanese patent application unexamined publication No. Hei 4-349273 (hereinafter, referred to as patent literature 1), the same data is written in two parts of one hard disk device. Therefore, at the time of storing data, the device is controlled in such a way that data is stored in the first storage position in step S1 and the same data (mirror data) is stored in the second storage position in step S2. According to the difference between the two storage positions, the following four types of hard disk devices are provided.
(1) Same data is stored in another sector on the same track on the same surface on the same circular disk
(2) Same data is stored in another sector on another track on the same surface on the same circular disk
(3) Same data is stored in another sector on another track on another surface on the same circular disk
(4) Same data is stored in another sector on another track on another surface on another circular disk

In the invention disclosed in Japanese patent application unexamined publication No. Hei 3-76003 (hereinafter, referred to as patent literature 2), the invention is configured to comprise a plurality of read or write heads each of which correspond to any one of the surfaces on a plurality of magnetic disks). According to this configuration, a series or parallel conversion circuit is provided for each read or write head and the plurality of read or write heads independently moves so that the read and write processing of data can be simultaneously performed. Accordingly, this increases the use efficiency of heads, shortens a data processing time and accordingly enhances the processing performance.

Furthermore, the invention disclosed in, for example, Japanese patent application unexamined publication No. Hei 2002-100128 (hereinafter, referred to as patent literature 3) comprises ahead stack assembly that is provided with a plurality of actuator blocks capable of independently rotating for the support of a plurality of magnetic heads that access multiple-stage magnetic disks. In addition, the invention performs in parallel both the processing of writing data while dispersing the data to the plurality of magnetic disks and the processing of reading the written data. By performing the above-mentioned processing, the invention realizes the execution of processing at high speed while increasing a storage capacity. Furthermore, according to this invention, by setting both the magnetic head of each actuator block and a magnetic disk accessed by this magnetic head as one unit and installing necessary functions in this unit, one magnetic disk device can be utilized, that is, in the same way as RAID (Redundant Arrays of Inexpensive Disks), as an easy way.

In the invention disclosed in Japanese patent application unexamined publication No. 7-49750 (hereinafter, referred to as patent literature 4), a disk array device is configured by combining a plurality of disk devices each of which is provided with two systems of read or write mechanism that can access the same surface of a disk medium. This disk array device is configured to perform a recovery operation and a response to the access from a host using different read or write mechanisms, thereby performing the two bits of processing in parallel.

In the invention disclosed in Japanese patent application unexamined publication No. 2001-307410 (hereinafter, referred to as patent literature 5), replication can be automatically prepared when high-capacity continuous data such as AV data, etc. are written so that a mirroring RAID system can be realized using a single magnetic disk device. In this patent literature 5, the number of switching times, etc. of a magnetic head are obtained by setting a switching time of a magnetic head, a cylinder seek time and the number of magnetic heads installed in a magnetic disk device. Then, the transferred data is written in a magnetic disk, the magnetic head is switched and a replication of the transferred data is written on another record surface on the same magnetic disk or on the record surface on another magnetic disk. Alternatively, a processing of writing the transferred data only in one sector on a magnetic disk and then writing a replication of the data in the continuing sector is repeated, thereby storing a plurality of replication data on a single magnetic disk.

In the invention described in Japanese patent application unexamined publication No. 8-83152 (hereinafter, referred to as patent literature 6), the following problem is solved. At the time of performing processing of (1) reading old data and an old parity, (2) preparing a new parity and (3) writing new data and the new parity in a disk array device called RAID5, waiting time is required when the writing processing (3) is performed since a disk rotates almost one round during the processing (1) and (2). Therefore, in the patent literature 6, two heads are provided for one actuator (one arm) at different positions on the same circumference in the rotation direction of a disk. The first head positioned in front is used as a read only head while the second head positioned in the back is used as a write only head. Thus, the write processing of (3) can be performed in the same disk rotation period as those of the processing of (1) and (2).

When the above-mentioned conventional technologies each of which configures RAID in a single disk device are roughly classified, the following two categories are obtained.
(a) Method of overlapping data or writing divided data and the parity on a plurality of disk surfaces (hereinafter, referred to as a plural-surface RAID method).
(b) Method of overlapping data or writing divided data and the parity on the same disk surface (hereinafter, referred to as a single-surface RAID method). That is, this method is a method of configuring RAID using one disk and furthermore one surface.

In the plural-surface RAID method, a plurality of disk surfaces is required and the number of disks configuring a magnetic disk device depends on the configuration of RAID. That is, for example, in the case of the configuration like RAIDs 3, 4 or 5 storing four divided data and the parity, five disk surfaces are required. In the method of using a plurality of actuators like the patent literature 3, etc., the configuration of the device and a control method thereof become complicated and accordingly the cost increases.

In a method of configuring RAID using one disk and furthermore only one surface, the number of disks does not depend on the configuration of RAID so that a disk device having an optional number of disks can be configured.

Therefore, a single-surface RAID method is preferable but there are the following problems to realize the conventional single-surface RAID method.

In the method of the patent literature 1, two-time data writing processing in steps S1 and S2 are required to realize a mirroring processing therefore a high-speed processing cannot be realized. This problem occurs also in the case of “repeating a processing of writing data in one sector on a magnetic disk and writing a duplication of the data in a continuing sector”.

The invention of the patent literature 4 is related to a recovery processing. It is conceivable that this invention realizes a single-surface RAID method of simultaneously accessing two positions on the same surface using a configuration such as “one disk device provided with two systems of read or write mechanism that can access the same surface of a disk medium” which is disclosed in the patent literature 4. In this case, too, however, a plurality of actuators is used so that the configuration of the device and a control method thereof become complicated like the patent literature 3 and accordingly the cost increases. In the configuration of the patent literature 3, the configuration of simultaneously accessing three or more positions, that is, three or more actuators are required to configure RAIDs 3, 4 and 5. However, since it is actually impossible to provide three or more actuators in one disk device, RAIDs 3, 4 and 5 cannot be actually realized.

The patent literature 6 discloses a configuration in which two heads are provided for each arm. However, these positions of the heads are different in the disk rotation direction and they are positioned on the same circumference. This configuration aims at performing a write processing in the same disk rotation period as that of a read processing.

Furthermore, in the case of autonomously configuring RAID in a magnetic disk device, this magnetic disk device is looked as only an ordinary disk (however, having a very low fault rate) from the external OS side (external controller). For example, even in a magnetic disk device configured like RAID1, it cannot be understood that data is made doubled (mirrored) when the device is looked from the external OS side. Therefore, in the case where redundancy is lost in such a magnetic disk device, an external controller cannot recognize that RAID is in a degenerate condition, using a general input or output command. Consequently, such a magnetic disk device cannot recover the redundancy to maintain the reliability.

When a disk and a head are collided with each other due to a head collision, etc., particles are scattered in a magnetic disk device and parts other than the collided parts are sometimes damaged. Especially, in the case of configuring RAID in a single magnetic disk device, when a plurality of parts is simultaneously damaged in anyway, there is a possibility that the lost data cannot be recovered and accordingly the reliability cannot be maintained.

### SUMMARY OF THE INVENTION

The present invention aims at offering a magnetic disk device, an access control method thereof, a program thereof and a storage medium thereof. This device configures RAID using one disk and furthermore only one surface without requiring a plurality of actuators and also enables a high-speed access processing by simultaneously accessing a plurality of tracks on the same surface in the case where RAID is configured in a single magnetic disk device.

Furthermore, the present invention aims at offering a magnetic disk device, etc. for recovering redundancy when redundancy is lost in the case where RAID is autonomously configured in a magnetic disk device.

In addition, the present invention aims at offering a magnetic disk device, etc. for preventing particles from being scattered and preventing parts other than a collided part from being damaged in the case of configuring RAID in a single magnetic disk device.

The magnetic disk device according to the present invention is a magnetic disk device for configuring RAID in a single disk device and this device is configured in such a way that a plurality of data access heads is provided for each arm and the plurality of data access heads are positioned to simultaneously access different tracks on the same surface on a disk.

This configuration can realize a method of configuring a magnetic disk device for configuring RAID in a single disk device and configuring RAID using one disk and furthermore only one surface, that is, the above-mentioned single-surface RAID method neither requiring a plurality of actuators nor performing a write processing, etc. several times. That is, a single-surface RAID method of writing, etc. a plurality of data using a single actuator can be realized.

Furthermore, a magnetic disk device for performing a control like RAID1 can be realized by further comprising a control unit for simultaneously writing the same data on different tracks on the same surface on the disk using the plurality of data access heads.

Alternatively, a magnetic disk device for performing a control like RAID3 can be realized by further comprising a control unit for, when writing data, dividing the data and generating a plurality pieces of parity in accordance with a plurality of the divided data and for simultaneously writing the plurality of the divided data and each parity on different tracks on the same surface on the disk using the plurality of data access heads.

Furthermore, the control unit performs the positioning on the basis of one of the plurality of data access heads.

According to the magnetic disk device of the present invention, a plurality of heads is provided for each arm and at the time of gaining access to an optional position on a disk, the positioning is determined on the basis of one of the plurality of heads.

Furthermore, at the time of continuous accesses, a track skew such that a rotational latency becomes minimum corresponding to a long-distance seek where the heads move equal to or more than two tracks at one time is set in addition to a track skew corresponding to one track seek.

Generally, when, for example, high-capacity data is written, the data is written while seeking an arm for each track since a plurality of tracks are continuously accessed. At this time, a skew (position of the head sector on a track) corresponding to one track seek is adjusted. The same processing is performed when data is read out.

On the contrary, the magnetic disk device of the present invention is configured in such a way that a plurality of heads is provided for each arm and different tracks on the same disk surface are simultaneously accessed. Therefore, in the case of using, for example, two heads depending on circumstances, it is necessary to seek tracks for the distance approximately identical to a distance between the two heads (long-distance seek) In accordance with this seek, the adjustment of a skew is performed based on the long-distance seek

In this way, a rotation latency at the time of continuously gaining access to tracks including not only one track seek but also a long-time seek can be controlled.

In the case where a redundancy degree becomes less than a predetermined value in the configuration of performing a control like, for example, RAID 1, data of a loss occurrence part may be written in a backup region based on the data of another track corresponding to the loss occurrence part.

Furthermore, in the case where any divided data is lost in the configuration of performing a control like, for example, RAID 3, the lost data may be reconfigured to be written in a backup region based on another divided data and the parity.

In this way, the lost data can be recovered from a degenerate condition by autonomously writing data of the damaged part in a switching sector region in a magnetic disk device.

Alternatively, it is appropriate that a fact such that data is in a degenerate condition is informed to an external controller and the data is recovered from the degenerate condition using an external controller, in place of the method of autonomously recovering data from a degenerate condition in the magnetic disk device, which is mentioned above.

In this case, a loss occurrence part is informed by an external controller using an address referred to by the external controller.

Another magnetic disk device of the present invention is a magnetic disk device for configuring RAID in a single disk device. In a magnetic disk device comprising a plurality of multiple-stage magnetic disks on the same rotation axis, this device is configured to insert partitions made from adsorbent materials among the respective magnetic disks.

In this way, even in the case where particles are generated by head collision, etc. at a certain part, the particles are immediately adsorbed to adsorbent materials near the collision occurrence part. Therefore, it is possible to prevent the particles from being scattered in the magnetic disk device, thereby preventing parts other than the collision occurrence part from being damaged. Especially, in the case where RAID is configured in a single magnetic disk device, it is possible to recover lost data even if a plurality of parts is simultaneously damaged and consequently the reliability can be maintained.

### BRIEF DESCRIPTION OF THE DRAWINGS

The present invention is further clarified by referring to the below detailed explanation together with the attached drawings.

Each of FIGS. 1A and 1B shows one example of a configuration having a plurality of magnetic heads, FIG. 1A shows one example of a configuration having two magnetic heads and FIG. 1B shows one example of a configuration having three magnetic heads;

Each of FIGS. 2A and 2B shows a positional relation at the time of an access using a plurality of magnetic heads, FIG. 2A shows an example of using two magnetic heads and FIG. 2B shows an example of using five magnetic heads;

FIG. 3A shows a whole configuration of a magnetic disk device according to the present preferred embodiment and FIG. 3B is a block diagram of a control device of the magnetic disk device;

FIG. 4 is a flowchart for explaining a basic access control processing performed by the control device;

Each of FIGS. 5A and 5B shows control processing like RAID 1 and FIG. 5A is a flowchart of processing at the time of writing data while FIG. 5B is a flowchart of processing at the time of reading data;

Each of FIGS. 6A and 6B shows control processing like RAID 3 and FIG. 6A is a flowchart of processing at the time of writing data while FIG. 6B is a flowchart of processing at the time of reading data;

FIG. 7 is a flowchart for the explanation of a specific example of a positioning processing;

FIG. 8 explains a long-distance skew control in a magnetic disk device according to the present preferred embodiment;

FIG. 9 is a flowchart for explaining recovery processing from a degenerate condition;

FIG. 10 is related to the processing shown in FIG. 9 and shows one specific example (No.1);

FIGS. 11A and 11B are related to the processing shown in FIG. 9 and show specific examples (No. 2) and (No.3), respectively;

FIG. 12 shows a block diagram for preventing particles from being scattered; and

FIG. 13 shows a schematic hardware configuration of a whole data processing device (server, etc.) which installs a magnetic disk device according to the present preferred embodiment.

### DESCRIPTION OF THE PREFERRED EMBODIMENT

The following is the explanation of the preferred embodiment of the present invention in reference to the drawings.

Each of FIGS. 1A and 1B shows one example of the configuration of a data access head provided in a magnetic disk device according to the present preferred embodiment.

Each of FIGS. 2A and 2B shows a positional relation of the data access heads on a disk surface, according to the present preferred embodiment.

A magnetic disk device is provided with a plurality of data access heads (here, magnetic heads) for each arm, according to the present preferred embodiment. FIG. 1A shows one example in which two magnetic heads are provided and FIG. 1B shows one example in which three magnetic heads are provided. The present preferred embodiment is not limited to these configurations and a configuration in which four or more magnetic heads are provided is also applicable.

In the example of FIG. 1A, magnetic heads (magnetic poles) 1 and 2 are respectively provided on rails on both sides of a slider provided near the leading edge of one optional arm (not shown in the drawing).

In the example of FIG. 1B, another rail is provided between the two rails and a magnetic head is also provided on this rail so that magnetic heads 1, 2 and 3 are respectively provided on three rails of the slider as shown in the figure. A configuration in which four or more magnetic heads are provided is prepared in the same way as in this configuration.

The configuration in which a plurality of magnetic heads is provided for each arm is disclosed in the patent literature 6. In the present preferred embodiment, however, the positional relation of the plurality of magnetic heads to a magnetic disk is different (primarily, the object is different).

Each of FIGS. 2A and 2B shows this positional relation.

FIG. 2A shows the positional relation of the two magnetic heads to a magnetic disk 10 in the configuration in which two magnetic heads are provided for each arm.

As shown in the drawing, at the time of an access, the two magnetic heads 1 and 2 are positioned to face different tracks on the same surface on the magnetic disk 10.

By configuring magnetic heads in this way, it is possible to simultaneously write or read data on or from different tracks on the same surface on the magnetic disk, using one arm. In the case where data to be written in two magnetic heads are, for example, optional data and the replication of the optional data, that is, the same data A, it is possible to configure a magnetic disk device in such a way that the same data can be simultaneously written on only one surface on the magnetic disk 10 using one arm, that is, it is possible to configure a magnetic disk device like RAID1 using one magnetic disk and furthermore only one surface.

If the width of a slider is, for example, 1 mm and the width of a track is, for example, 0.4 μm, 2500 tracks are present between heads but here the figure is simplified. Meanwhile, the distance between heads can be optionally determined.

FIG. 2B shows the positional relations of five magnetic heads to a magnetic disk in a configuration in which five magnetic heads are provided for each arm.

As shown in the figure, the five magnetic heads are positioned to respectively face different tracks on the same surface on a magnetic disk at the time of an access.

Then, a configuration in which, for example, optional data to be written in a disk is divided into four, each parity is generated in accordance with these four divided data A, B, C and D, and these four divided data and the parity are simultaneously written on different tracks on a same surface on the magnetic disk 10 using the five magnetic heads can be obtained. At the same time, a configuration in which these data and parities are simultaneously read out, that is, a magnetic disk device like RAID3 can be also obtained.

As is well-known, in the case where, for example, divided data A is lost, the lost data A can be restored by the EXCLUSIVE-OR operation of other divided data B, C and D and the parity.

The reason why such a technology is called a technology like RAID3 depends on the point of view. In RAID3, access controls are simultaneously performed on both the divided data and the parity. In the present preferred embodiment, the same controls are performed and accordingly, a technology of the present preferred embodiment is named a technology like RAID3.

According to the above-mentioned configuration, in the magnetic disk device of the present preferred embodiment, RAID can be configured using one disk and furthermore only one surface neither requiring a plurality of actuators nor performing a writing or reading processing while dividing this processing more than once. In other words, it becomes possible to simultaneously access a plurality of tracks on the same surface on a disk using a single actuator in a single-surface RAID method. Thus, processings can be performed at high speed without complicating the configuration. Furthermore, a magnetic disk device having an optional number of disks can be configured in such a way that the number of disks does not depend on the configuration of a RAID configuration. In addition, it is easy to prepare at low cost a plurality of magnetic heads as shown in the examples of FIGS. 1A and 1B, FIGS. 2A and 2B, etc. This configuration costs much lower than a configuration in which a plurality of actuators is provided.

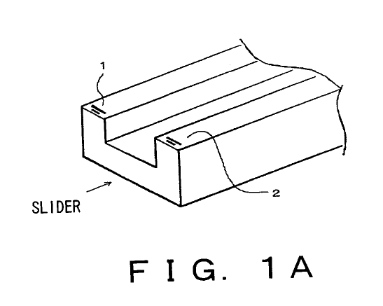

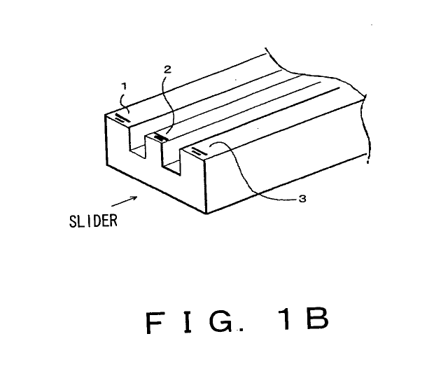

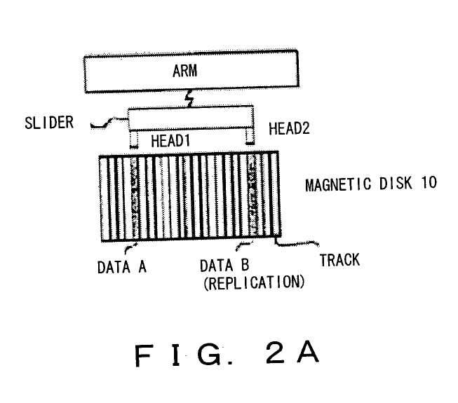

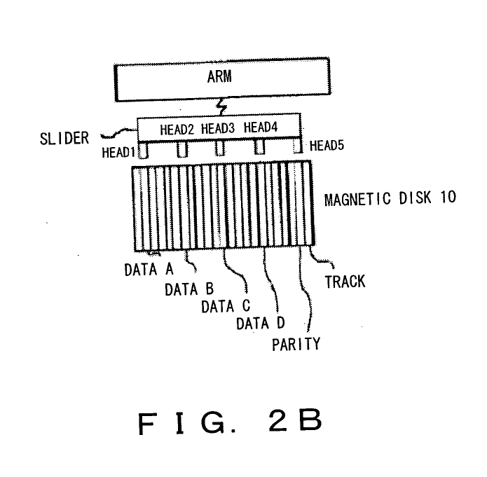

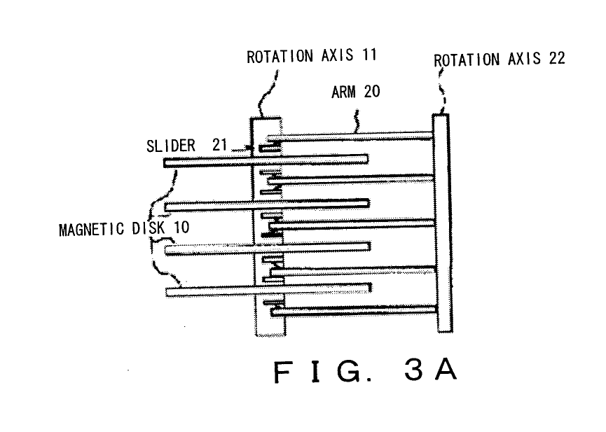

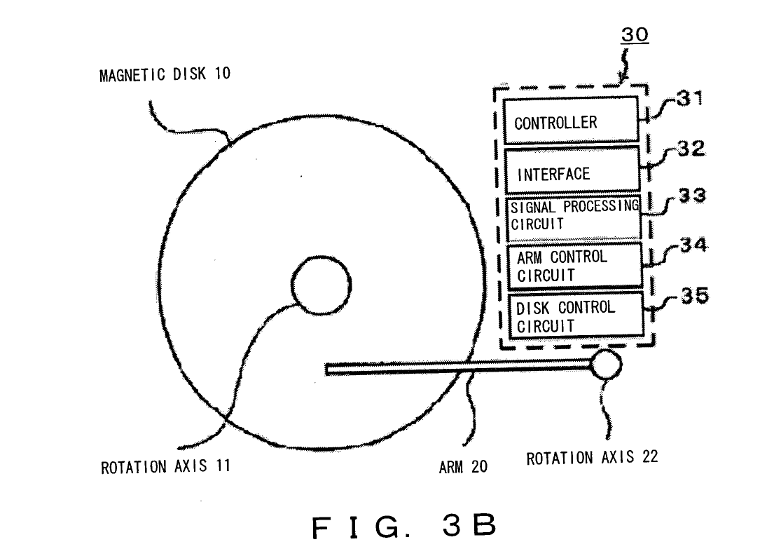

FIG. 3A shows one example of a whole configuration of a magnetic disk device according to the present preferred embodiment.

FIG. 3B is a block diagram showing the function of a control device of the magnetic disk device according to the present preferred embodiment.

The whole magnetic disk device according to the present preferred embodiment is explained in reference to FIGS. 3A and 3B. Meanwhile, the whole configuration as shown in each of FIGS. 3A and 3B is a general configuration. The characteristics of the magnetic disk device according to the present preferred embodiment are a configuration in which a plurality of magnetic heads are provided for each arm by providing a plurality of magnetic heads for each slider 21, a configuration in which the plurality of magnetic heads are positioned so as to simultaneously access different tracks on a same surface on the magnetic disk 10 and an access control method thereof.

In the example of FIG. 3A, a plurality of magnetic disks 10 is positioned on a rotation axis 11 at a predetermined distance and they are integrally rotary-driven by a spindle motor which is not shown in the figure.

In addition, a plurality of arms 20 is rotary-driven by a voice coil motor which is not shown in the figure while centering around one rotation axis 22 and the arms move magnetic heads provided at respective sliders 21 to predetermined positions on the magnetic disk 10. Here, this can be expressed in such a way that a plurality of arms is simultaneously operated to be moved by one actuator.

Near the leading end of each arm 21, the slider 21 is provided. As is well-known, a slider is also named a head slider. The slider is connected to the arm 20 via a support spring, etc. The support spring is positioned above the surface on a disk by approximately more than a dozen nm at the time of an access. For example, a taper flat type is used when a generally-known slider is shaped. The thus-shaped slider has rail parts on both sides thereof and the input part is tapered. According to the magnetic head of FIG. 1A, the magnetic head (magnetic pole) is provided at each of two rail parts in the case where the rail parts are provided at both sides of the slider. As mentioned above, these magnetic heads are positioned to simultaneously access different tracks on a same surface on the magnetic disk 10.

FIG. 3B shows the configuration of a control unit of the magnetic disk device.

The control unit 30 includes a controller 31, an interface 32, a signal processing circuit 33, an arm control circuit 34 and a disk control circuit 35.

The disk control circuit 35 controls the rotation of the magnetic disk 10. That is, this circuit controls the “spindle motor”.

The arm control circuit 34 is a circuit for controlling the “voice coil motor” and activates the arm 20, thereby moving the slider 21 (that is, a plurality of magnetic heads) to an optional position.

The signal processing circuit 33 is a circuit for simultaneously processing the inputs and outputs of a plurality of magnetic heads on the same arm 20. The circuit configuration is not especially shown but the circuit is provided with, for example, a plurality of buffers respectively corresponding to a plurality of magnetic heads. For example, in the case where a control like RAID3 is performed using the configuration of FIG. 2B, it is assumed that five buffers are provided, the four divided data and the parity are temporarily stored in each buffer and then they are simultaneously outputted.

The interface 32 is an interface with an external controller that is not shown in the figure (for example, a control unit of a server).

The controller 31 is a processor such as an MPU, etc, for controlling the whole control unit 30 and when a command of writing or reading data is received from an external controller via the interface 32, it performs a processing in accordance with this command.

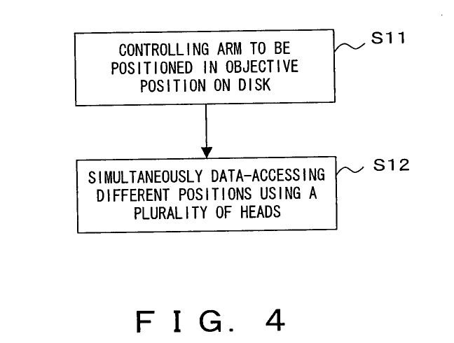

For example, the controller decides a magnetic head to be used, directs the arm control circuit 34 to control the arm 20 so as to move the magnetic head of the arm 20 to an objective position (step S11 of FIG. 4). Then, the controller directs the signal processing circuit 33 to simultaneously process the input and output processing of a plurality of magnetic heads on the arm 20. That is, it directs a plurality of magnetic heads on the same arm 20 to simultaneously access different tracks on the same surface on the magnetic disk 10 (step S12 of FIG. 4).

The following is the explanation of a control processing of the controller 31 in reference to the flowcharts of FIGS. 5 to 7 and 11.

The control processing shown in the flowcharts of FIGS. 4, 5 to 7 and 11 are realized by executing a predetermined program stored in the controller 31 by the controller 31 or by reading out a predetermined program that is stored in a memory that is not shown in the figure in the control device 30, thereby executing the program by the controller 31. This sentence can be also expressed in such a way that a computer carries out the control processing shown in the flowcharts of FIGS. 4, 5 to 7 and 11 by executing the program.

FIG. 5 shows control processing in the case where a magnetic disk device like RAID1 is configured using a plurality of magnetic heads that are configured as shown in FIGS. 1A and 2A. FIG. 5A shows processing at the time of writing data while FIG. 5B shows processing at the time of reading data.

In FIG. 5A, when the controller 31 receives a data write command from an external controller via the interface 32, it firstly determines magnetic heads to be used in accordance with this command and it directs the arm control circuit 34 to control the arm 20 so as to move the magnetic heads on the arm 20 to objective positions (step S21). Then, the controller directs the signal processing circuit 33 to simultaneously write the data to be written and the replication, that is, the same data using two magnetic heads on the arm 20. That is, the same data are simultaneously written on different tracks on the same surface on the magnetic disk 10 using two magnetic heads on the same arm 20 (step S22).

When the controller 31 receives a data read command from an external controller via the interface 32 as shown in FIG. 5B at the time of reading out the thus-written data, it determines a magnetic head to be used in accordance with the command and directs the arm control circuit 34 to control the arm 20 so as to move the magnetic heads on the arm 20 to objective positions (step S31). Then, the controller directs the signal processing circuit 33 to read the data using either one of two magnetic heads on the arm 20 (step S32). In the case where the data cannot be read out, the data is read out using the other magnetic head.

Each of FIGS. 6A and 6B shows a control processing in the case where a magnetic disk device like RAID3 is configured using a plurality of magnetic heads configured as shown in FIG. 2B. FIG. 6A shows a processing when data is written while FIG. 6B shows a processing when data is read.

Meanwhile, the following explanation is made on the assumption based on a configuration in which five magnetic heads are provided for each arm, corresponding to the configuration example of FIG. 2B but the present preferred embodiment is not limited to this configuration.

When the controller 31 receives the data write command from an external controller via the interface 32 as shown in FIG. 6A, it firstly determines a magnetic head to be used in accordance with the command and it directs the arm control circuit 34 to control the arm 20 so as to move the magnetic heads on the arm 20 to objective positions (step S41).

Furthermore, the controller divides data to be written into, for example, four, it generates each parity for the four divided data and then it directs each of five buffers in the signal processing circuit 33 to temporarily store the data and parity. Then, the signal processing circuit 33 directs the five magnetic heads on the arm 20 to simultaneously write the four divided data and the parity on different tracks on the same surface on the magnetic disk 10 (step S42).

At the time of reading out the thus-written divided data and the parity, when the controller 31 receives the data read command from an external controller via the interface 32 as shown in FIG. 6B, it determines magnetic heads to be used in accordance with the command and it directs the arm control circuit 34 to control the arm 20 so as to move the magnetic heads on the arm 20 to objective positions (step S51).

Then, the controller directs the signal processing circuit 33 to read the respective data stored on different tracks, that is, the four divided data and the parity using the five magnetic heads on the arm 20 (step S52).

In the case where the data that cannot be read is present for some reason (step S53, YES), the lost data is restored based on the three divided data and the parity that can be read out (step S54).

The subsequent processings are not especially drawn but the four divided data are combined, thereby restoring the original data to be transmitted to an external controller.

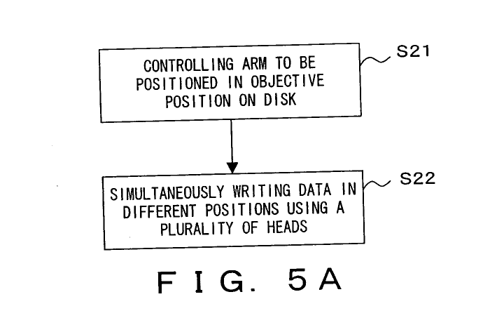

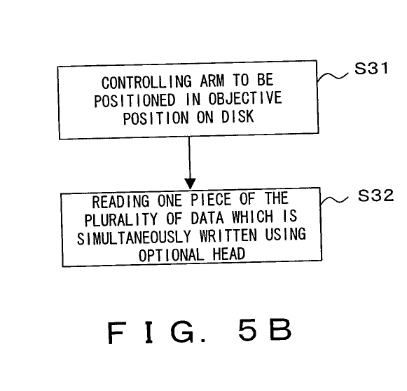

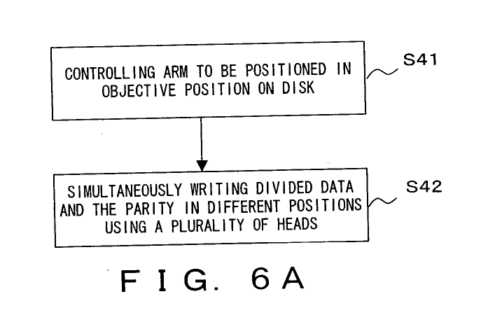

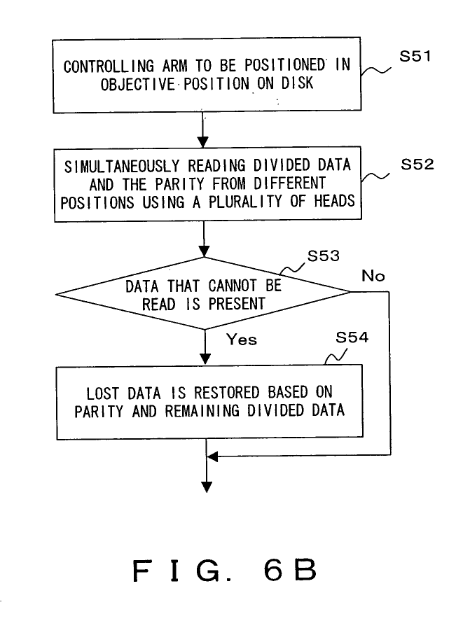

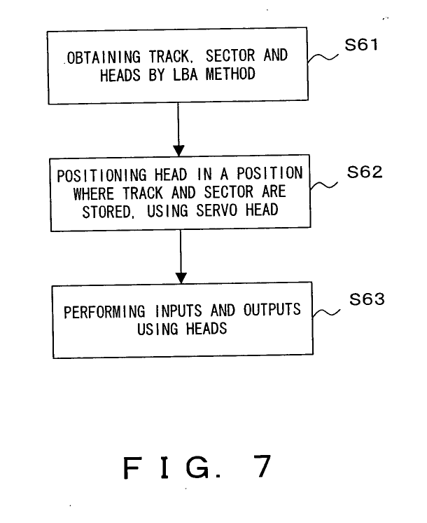

The following is the further specific examples of positioning processing in steps S11, S21, S31, S41 and S51 in reference to FIG. 7.

FIG. 7 is a flowchart for explaining specific example of the positioning processings.

Since in the magnetic disk device according to the present preferred embodiment, a plurality of magnetic heads is provided for each arm, a positioning processing is performed based on one predetermined magnetic head among the plurality of magnetic heads.

In the magnetic device according to the present preferred embodiment, in the same way as in an existing magnetic disk device, one surface on an optional disk among a plurality of disks is previously set a surface exclusively for use for servo information or a shared surface (hereinafter, referred to as a servo surface) and servo information (track ID, sector ID, etc.) is stored on the servo surface. That is, a “servo surface servo method” is used. In addition to this method, a method of embedding servo information at a part of a data track on each surface on each disk, that is, a “data surface servo method” is present in respect of the method of writing servo information. The present invention is not limited to the “servo surface servo method” but here this method is explained as one example.

In the present preferred embodiment, an “LBA (Logical Block Addressing) method” is used. As is well known, an LBA method is a method based on a concept such as a logical sector assigned consecutive numbers to all the sectors.

When the controller 31 receives a command the access destination of which is designated using a logical block address (LBA) method from an external controller via the interface 32, it firstly refers to a conversion table that is not shown in the figure, etc. and obtains the corresponding track ID and sector ID (step S61). Here, in the present preferred embodiment, a plurality of magnetic heads is used but it is sufficient to use one magnetic head among these magnetic heads for the positioning. In the conversion table, track ID and sector ID of one predetermined magnetic head are corresponded to each other to be stored for each logical block address (LBA). At that time, magnetic heads to be used corresponding to the command are also obtained.

A magnetic head provided on the arm 20, for accessing the “servo surface” is generally a single magnetic head (hereinafter, referred to as a servo head). A positioning processing terminates by referring to the servo surface and detecting the position where track ID and sector ID corresponding with the track ID and sector ID obtained in step S61 are stored, using the servo head (step S62). According to the configuration of the present preferred embodiment, once one magnetic head is positioned, other magnetic heads are accordingly positioned in predetermined positions.

Once the positioning terminates in this way, it is sufficient to write data or read data using the magnetic heads (step S63).

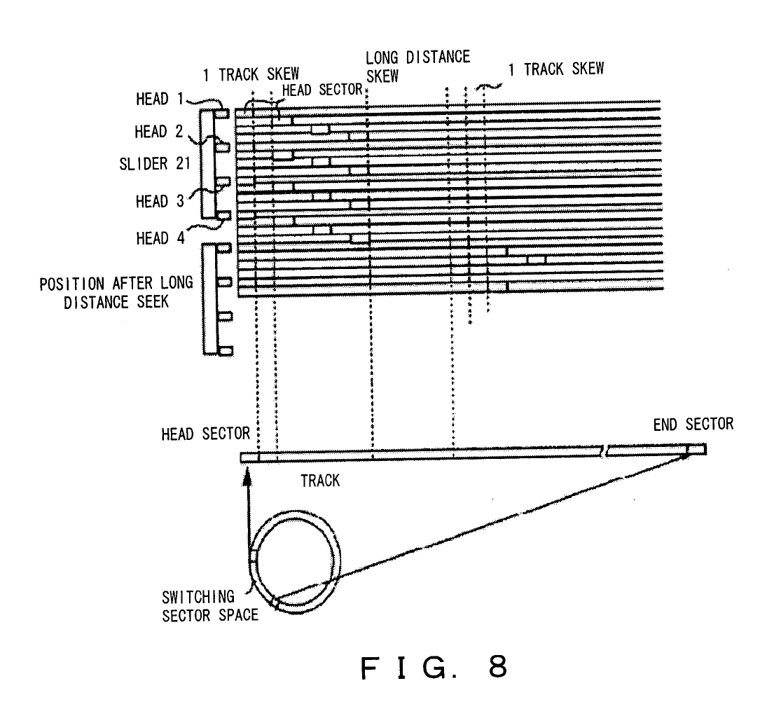

The following is the explanation of the control of a long-distance skew in the magnetic disk device according to the present preferred embodiment, in reference to FIG. 8.

Generally, when, for example, high-capacity data is written, etc., a plurality of tracks is continuously accessed so that data is written while seeking the arm 20 for each track one by one (moving a magnetic head to an adjacent track). The same processing is performed in the case of reading data.

At that time, the position of a head sector is shifted in consideration of a time required for one track seek. That is, the adjustment of a skew corresponding to one track seek (adjustment of a position of a head sector on a track) is performed. In this way, the rotational latency at the time of continuous accesses can be controlled. Meanwhile, the track skews corresponding to one track seek are all shifted by the same amount if the number of sectors for each track is the same.

In the magnetic disk device according to the present preferred embodiment, when the configuration shown in, for example, FIG. 2A is exemplified, two magnetic heads 1 and 2 access the positions that are apart by n tracks (n; optional integer) on the same surface. Therefore, at the time of continuous accesses, generally a seek is performed for each track. However, when n-1 tracks are accessed, a region from the track next to the magnetic head 1 is a region where data is written by the magnetic head 2 so that a distance for n tracks should be sought at one time. Here, this seek is called long-distance seek. The positioning of sectors in consideration of a seek time required for a long-distance seek corresponds to a method of controlling a long-distance skew.

FIG. 8 shows the visually apparent explanation of the above-mentioned long-distance skew. In FIG. 8, a configuration in which four magnetic heads are provided on one arm is exemplified.

As shown in FIG. 8, in respect of one track seek, it is sufficient to store the sector ID on a servo surface in such a way that a sector that is physically shifted from the position in the previous track becomes a head sector in the next track according to the seek time.

Basically the same processing is performed for a long-distance seek but it is necessary to adjust the skew in accordance with the seek time since the seek time becomes relatively long.

An optimal skews 1 for one track seek can be obtained by the following equation (1) using one track seek time t1, a time T necessary for one rotation of a disk and the number n of sectors on a track that can be obtained by a designer, etc. of the device.
S1=n×t1/T equation (1)

In the same way as the above-mentioned equation, a long-distance seek time t2 can be obtained in advance so that an optimal skew s2 for a long-distance seek can be obtained by the following equation (2).
S2=n×t1/T equation (2)

Accordingly, by setting and storing the sector ID on a servo surface based on the thus-obtained skews s1 and s2, one track skew and a long-distance skew can be controlled. That is, an optimal positioning processing can be performed based on a conventional control method.

In the case where the controller 31 further seeks the predetermined specific track after accessing this track while corresponding to the set and stored sector ID on the servo surface as mentioned above, it performs a long-distance seek. The sector ID on a servo surface on a track that is accessed based on the long-distance seek is set in accordance with the long-distance skew.

The following is the explanation of a recovery processing from a degenerate condition.

In the case where redundancy is lost in the magnetic disk device for configuring RAID, it is necessary to recover the redundancy to maintain reliability. In other words, it is necessary to recover the device from the degenerate condition when the device is in a degenerate condition. The case where redundancy is lost is the case where the redundancy is less than a predetermined value in a magnetic disk device when the configuration is like RAID1 of FIG. 2A. Furthermore, when the configuration is like RAID3 of FIG. 2B, the case where redundancy is lost means a case where any of divided data or the parity is lost.

However, in the case where RAID is autonomously configured in a magnetic disk as mentioned above, an external controller cannot recognize that the RAID is in a degenerate condition, using a general input or output command.

The present preferred embodiment proposes two methods of solving such a problem.

The first method is a method of informing a loss occurrence part to an external controller using an address (logical address) that is referred to by the external controller when the redundancy is lost. The external controller that receives such notice of the loss occurrence part reads out the data about the loss occurrence part (for example, replication data corresponding to the lost data in the case of mirroring) and performs a processing of copying this data in a not-used region or on another disk. Thus, the degenerate condition is recovered.

The second method is a method of recovering from a degenerate condition by autonomously writing the data of a damaged part in a switching sector region in a magnetic disk device when the redundancy is lost, that is, a method of performing a switching processing. Meanwhile, the switching sector region is a backup region that is prepared in advance for a defect processing.

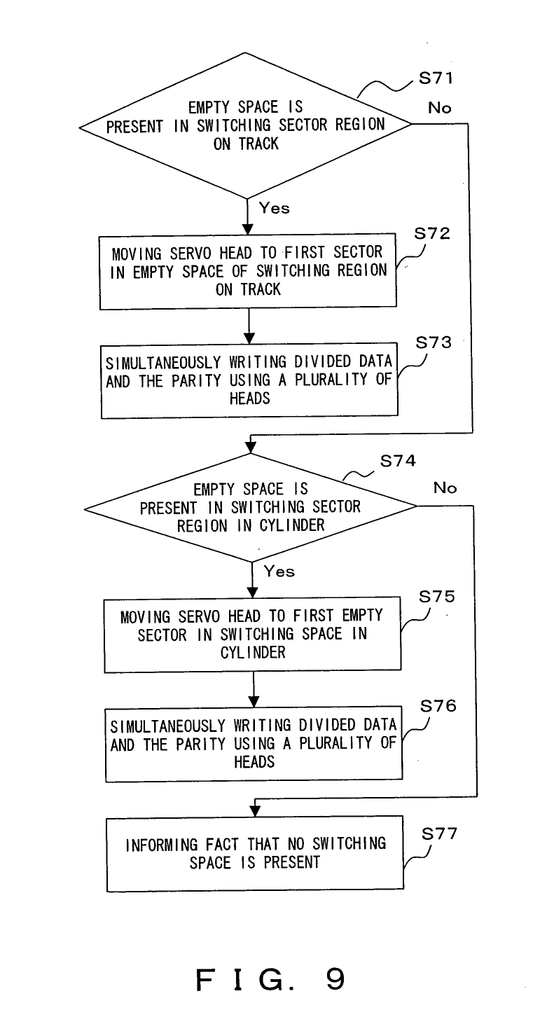

The following is the explanation of the second method in reference to FIGS. 9 to 11.

Each of FIGS. 9 to 11 explains a switching processing in the case where any one of divided data or any parity is lost in the configuration like RAID3 of FIG. 2B.

FIG. 9 is a flowchart for explaining switching processing according to the present preferred embodiment.

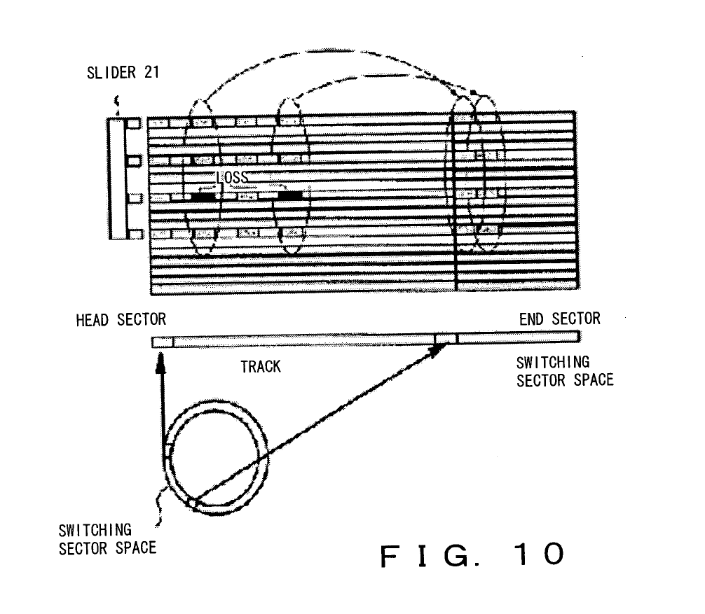

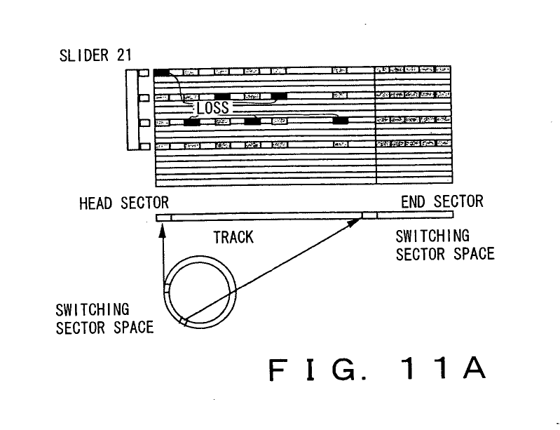

Each of FIGS. 10, 11A and 11B shows one specific example for the explanation of the processing of FIG. 9. Each of FIGS. 10, 11A and 11B exemplifies a configuration in which four magnetic heads are provided for each arm and three of the four magnetic heads read or write the divided data while one of them reads or writes the parity.

As mentioned above, a switching sector region that is a backup region prepared in advance for a defect processing is present on a magnetic disk. For example, as shown in FIG. 10, for each track, a region from the head sector to the end sector is set as a switching sector region.

The processing of FIG. 9 is started after three divided data and the parity are read out from an optional position using four magnetic heads, a fact such that any one of these divided data or any parity is lost is detected and the lost data (the divided data or the parity) is restored using another data.

In FIG. 9, it is first checked whether or not an empty space is present in the switching sector region on a track on which a loss occurs (step S71). In the case where an empty space is present (step S71, YES), the positioning processing is performed by firstly controlling a servo head and moving the servo head to the position of the first sector in an empty space in this switching sector region (step S72). In this position, three divided data and the parity are simultaneously written using the four magnetic heads (step S73). Thus, for example, as shown in FIG. 10, the lost data, another divided data and the parity are written in a switching sector region and the lost data can be recovered from a degenerate condition.

When the above-mentioned processing is performed each time lost data occurs, the switching sector region on a track eventually goes into a condition such that there is no empty space (step S71, NO).

In this case, it is further checked whether or not there is any empty space in a switching sector region on another disk surface in the same cylinder. In the case where there is no empty space (step S74, NO), a fact that no switching space to be used is present is informed (step S77). In the case where an empty space is present (step S74, YES), the positioning processing is performed by controlling the servo head and by moving the servo head to the position of the first sector in an empty space in this switching sector region (step S75). In this position, three divided data and the parity are simultaneously written using four magnetic heads corresponding to a disk surface on which a switching sector in the cylinder is present (step S76). In this way, as shown in, for example, FIG. 11B, the lost data, another divided data and the parity are written in a switching sector region in a cylinder and the lost data can be recovered from a degenerate condition.

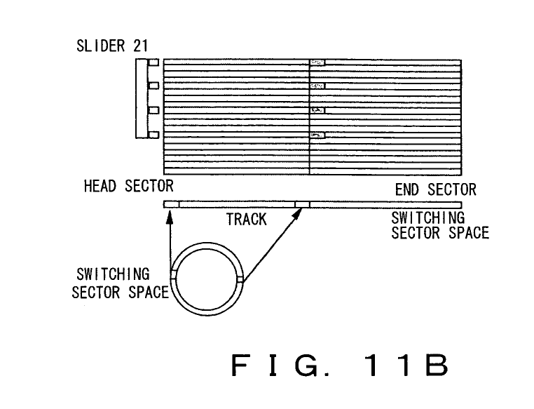

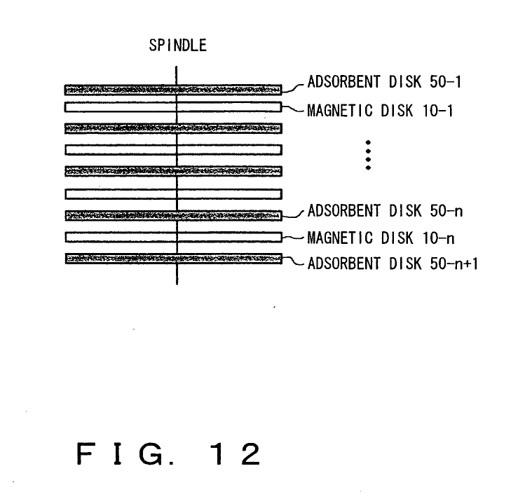

The following is the explanation of a preferred embodiment for preventing particles from being scattered in the case where RAID is configured in a single magnetic disk device, in reference to FIG. 12.

The configuration of the present preferred embodiment is obtained by inserting adsorbent disks 50-1 to 50-n+1 that are circular plates made from adsorbent materials among a plurality of magnetic disks 10-1 to 10-n that are configured to be multiple-stage on the same rotation axis, as shown in FIG. 12. Meanwhile, strictly speaking, the adsorbent disks 50-1 and 50-n+1 are not inserted among magnetic disks, but here they are treated in the same way as other adsorbent disks.

In respect of the circular plate made from adsorbent materials, it is not necessary to specify the material and accordingly if the surface is adsorbent, any circular plate is available. Even if, the material of the circular plate is not adsorbent, a circular plate the surface of which is coated with adsorbent paint is also available.

In this way, even if particles are generated at a certain part by head collision, etc., the particles are immediately adsorbed to an adsorbent disk 50 near the generated part so that it is possible to prevent the particles from being scattered in a magnetic disk device. This makes possible to prevent parts other than the collided part from being damaged. Especially, in the case where RAID is configured in a single magnetic disk device, this enables lost data to be restored by preventing a plurality of parts from being damaged simultaneously.

As mentioned above, various types of processing and functions as shown in flowcharts of FIGS. 4, 5 to 7 and 11, etc. are realized by executing a predetermined program by a control device having the controller 31, etc. in the magnetic disk device. The above mentioned program is stored in a ROM in a magnetic disk drive and the program can be downloaded from outside via an interface 32 to rewrite the ROM.

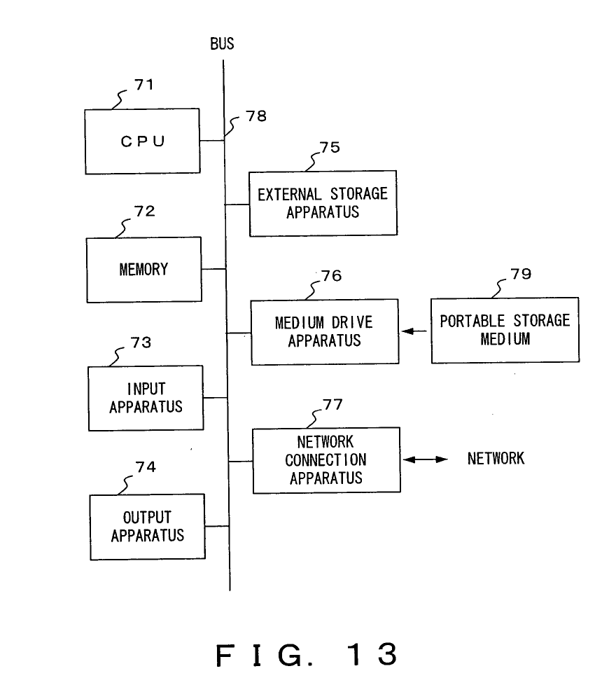

Lastly, FIG. 13 shows a whole outlined hardware configuration of an information processing unit (server, etc.) provided with the above-configured magnetic disk device.

An information processing unit 70 as shown in the figure includes a CPU 71, a memory 72, an input device 73, an output device 74, an external storage device 75, a medium driving device 76 and a network connection device 77, etc. and these devices are connected by a bus 78. The configuration shown in this figure is one example and the present invention is not limited to this configuration.

The CPU 71 is a central processing unit for controlling the whole information processing unit 70. The memory 72 is a memory such as a RAM, etc. for temporarily storing programs or data that are stored in the external storage device 75 (or a portable storage medium 79) when the programs are executed, the data are updated or the like.

The input device 73 includes, for example, keyboards, mouse, touch panels, etc.

The output device 74 includes, for example, displays, printers, etc.

The external storage device 75 includes, for example, the magnetic disk device (hard disk drive) configured according to the present preferred embodiment. This magnetic disk device performs processing such as a data write processing and a data read processing, etc. in accordance with commands from an external controller, that is, from the main body side of the information processing unit 70.

The medium driving device 76 reads or writes programs, data, etc. that are stored in the portable storage medium 79. The portable storage medium 79 includes, for example, an FD (flexible disk), a CD-ROM, a DVD, a magnet-optical disk, etc.

The network connection device 77 is connected to a network and is configured to enable programs, data, etc. to be transmitted and received (downloaded, etc.) from another external information processing unit.

As explained above in detail, according to the magnetic disk device of the present invention, an access control method thereof, a program thereof and a storage medium thereof, RAID can be configured using one disk and furthermore only one surface without requiring a plurality of actuators and it is also possible to perform an access processing at high speed by simultaneously accessing a plurality of tracks on the same surface, in the case of configuring RAID in a single magnetic disk device.

Even if a redundancy degree is lost in the case where RAID is autonomously configured in a magnetic disk device, the redundancy can be recovered.

Furthermore, in the case where RAID is configured in a single magnetic disk device, the present invention can prevent particles from being scattered and parts other than the collided part from being damaged, thereby restoring the lost data.

1. A magnetic disk device for configuring RAID in a single disk device, wherein
a plurality of data access heads is provided for each arm and the plurality of data access heads is configured in such a way that they are positioned to simultaneously access different tracks on a same surface on a disk.

2. The magnetic disk device according to claim 1, comprising
a control unit for directing the plurality of data access heads to write same data on different tracks on a same surface on the disk.

3. The magnetic disk device according to claim 1, comprising
a control unit for, when data is written, dividing the data and generating a plurality pieces of parity according to a plurality of the divided data and for directing the plurality of data access heads to simultaneously write the plurality of the divided data and the parity on different tracks on a same surface on the disk.

4. The magnetic disk device according to claim 3 wherein
the control unit directs the plurality of access heads to simultaneously read the plurality of the divided data and the parity from different tracks on a same surface on the disk when data is read out and it reconfigures the lost data using another divided data and the parity in a case where lost data is present.

5. The magnetic disk device according to claim 1, wherein
the control unit performs a positioning processing based on one of the plurality of data access heads.

6. The magnetic disk device according to claim 1, wherein
at a time of continuous accesses, a track skew such that a rotation latency is minimum corresponding to a long-distance seek where the plurality of data access heads move two or more tracks at one time is set in addition to a track skew corresponding to one track seek.

7. The magnetic disk device according to claim 2, wherein
in a case where a redundancy degree is less than a predetermined value, based on data of another track corresponding to a loss occurrence part, data of the loss occurrence part is written in a backup region.

8. The magnetic disk device according to claim 3, wherein
in a case where any of the divided data is lost, the lost data is reconfigured based on another divided data and the parity, and the reconfigured data is written in a backup region.

9. The magnetic disk device according to claim 2, wherein
in a case where a redundancy value is less than a predetermined value, a loss occurrence part is informed using an address that is referred to by an external controller.

10. The magnetic disk device according to claim 3, wherein
in a case where any of the divided data or the parity is lost, a loss occurrence part is informed using an address that is referred to by an external controller.

11. A magnetic disk device for configuring RAID in a single disk device and having a plurality of multiple-stage magnetic disks on a same rotation axis, wherein
partitions of adsorbent materials are inserted among the plurality of magnetic disks.

12. An access control method of controlling an access to a magnetic disk, comprising
simultaneously writing same data on different tracks using each of a plurality of data access heads that are provided for each arm and are positioned so as to simultaneously access different tracks on a same surface on a disk.

13. An access control method of controlling an access to a magnetic disk, comprising:
dividing data to be written;
generating a plurality pieces of parity in accordance with the divided data; and
simultaneously writing a plurality of the divided data and the parity on different tracks on a same surface on the disk using each of a plurality of data access heads that are provided for each arm and are positioned so as to simultaneously access different tracks on a same surface on a disk.

14. An access control method of accessing to a magnetic disk, comprising:
using each of a plurality of data access heads that are provided for each arm and are positioned so as to simultaneously access different tracks on a same surface on a disk, simultaneously reading out a plurality of divided data and a plurality pieces of parity from different tracks on a same surface on the disk; and
in a case where lost data is present, reconfiguring the lost data using another divided data and the parity.

15. A conveyance signal conveying a program for a magnetic disk device, wherein
the program directs the magnetic disk device to perform,
simultaneously writing same data on different tracks on a same surface on a disk using each of a plurality of data access heads that are provided for each arm and are positioned so as to simultaneously access different tracks on a same surface on a disk.

16. A conveyance signal conveying a program for a magnetic disk device, wherein
the program directs the magnetic disk device to perform:
dividing data to be written;
generating a plurality pieces of parity in accordance with a plurality of the divided data; and
simultaneously writing the plurality of the divided data and the parities on different tracks on a same surface on a disk using each of a plurality of data access heads that are provided for each arm and are positioned so as to simultaneously access different tracks on a same surface on the disk.

17. A computer-readable storage medium storing a program for directing a computer to perform,
using each of a plurality of data access heads that are provided for each arm and are positioned so as to simultaneously access different tracks on a same surface on a disk, simultaneously writing same data on different tracks on a same surface on the disk.

18. The computer-readable storage medium storing a program for directing a computer to perform:
dividing data to be written;
generating a plurality pieces of parity in accordance with a plurality of the divided data; and
using each of a plurality of data access heads that are provided for each arm and are positioned so as to simultaneously access different tracks on a same surface on a disk, simultaneously writing a plurality of the divided data and the parity on different tracks on a same surface on the disk.
